(19) United States
(12) Patent Application Publication
(10) Pub. No.: US 2007/0094197 A1
(43) Pub. Date: Apr. 26, 2007

(54) Medical diagnosis including graphical user input

(76) Inventors: Stephen Jay Datena, Portland, OR (US); Bart Eugene Lonchar, Portland, OR (US); Lawrence C. Gray, Saratoga, CA (US)

Correspondence Address: ROBERT D. VARITZ, P.C., 4915 SE 33RD PLACE, PORTLAND, OR, 97202, US

(21) Appl. No.: 11/500,828

(22) Filed: Aug. 8, 2006

Related U.S. Application Data
(63) Continuation-in-part of application No. 10/367,302, filed on Feb. 14, 2003.
(63) Continuation-in-part of application No. 10/999,045, filed on Nov. 29, 2004.
(60) Provisional application No. 60/358,947, filed on Feb. 22, 2002.
(60) Provisional application No. 60/708,035, filed on Aug. 11, 2005.
(60) Provisional application No. 60/789,436, filed on Apr. 4, 2006.

(51) Int. Cl. G06N 5/02

(52) U.S. Cl. 706/46

(57) ABSTRACT

A graphics endowed, computer-based system, and an associated methodology, for performing diagnoses of medical problem-types. The system and methodology utilize (a) a digital computational engine, (b) a database operatively connected to the engine including a storage medium which contains medical-problem-type-related, anatomical, graphics data components, some of which have characteristics of non-normalization that are linked through relevance short-cutting to other components which have characteristics of normalization, and (c) a user-interactive, graphical interface including a display screen operatively connected both to the engine and to the database, operable under engine control to display selected ones of the mentioned graphics data components in both user-interactive sensitized-input, and user-informative-output, modes during medical problem-type diagnosis performed by the system.

### CROSS-REFERENCES TO RELATED APPLICATIONS

This application is a Continuation-in-Part from U.S. Regular patent application Ser. No. 10/367,302, filed Feb. 14, 2003, for “Computer-Based Intelligence Method and Apparatus for Assessing Selected Subject-Area Problems and Situations”, which regular application claims priority to U.S. Provisional Patent Application Ser. No. 60/358,947, filed Feb. 22, 2002, for “Computer-Based Intelligence Method and Apparatus for Assessing Selected Subject-Area Problems and Situations”. The present application is also a Continuation-in-Part from U.S. Regular patent application Ser. No. 10/999,045, filed Nov. 29, 2004, for “Improved Computer-Based Intelligence Method and Apparatus for Assessing Selected Subject-Area Problems and Situations”. Additionally, the present application claims priority to U.S. Provisional Patent Application Ser. No. 60/708,035, filed Aug. 11, 2005, for “Graphical-Entry Medical Diagnosis”, and to U.S. Provisional Patent Application Ser. No. 60/789,436, filed Apr. 4, 2006, for “Intuitive Computer-Based Medical Diagnostic Interface”.

The entire disclosure contents of these several, prior-filed applications are hereby incorporated herein by reference.

### BACKGROUND AND SUMMARY OF THE INVENTION

This application relates to a medical diagnosis and assessment method, apparatus, and system for assessing different medical problem types, and which employs (a) a unique knowledge engine, an associated, (b) a unique graphical-image-based (still and motion) and text-based data-component database, or library, (c) a two-way, user-interactive, display-screen interface, and (d) other structure, to perform focused assessments and diagnoses of various medical problems and situations (medical problem types). In particular, it discloses such an invention which strongly mimics the natural human thought process, and which is endowed with a powerful interactive and adaptive capability to grow and “learn” in the subject area of medicine to which its “attention” is directed. Even more specifically, the invention addressed herein constitutes an improvement, or improvements, over and in relation to the inventions disclosed in the above-mentioned U.S. Regular Patent Applications. As will be seen, this/these improvement(s) relate(s) to the significant introduction of user-interactive, data-component-supported, graphical input and output capabilities which cross-link text-based and graphics-based data components (database content) in association with different medical problem types, and which furnish a user with an enhanced, intuitive interaction engagement with the system and practice of the invention.

The underpinning core of the present invention marks a significant departure from conventional, so-called artificial intelligence systems and processes. It offers a notable opportunity, enhanced with two-way, intuitive graphics capabilities, to fulfill the long-standing desire to link the processing power of a computer to an algorithmic approach which truly patterns medical-diagnosis performance closely to the ways in which the human mind trained in medicine actually processes medical diagnostic information. With this desire held in mind, conventional artificial intelligence machines and methods have two general limitations. First of all, they are usually based upon linear decision processes. Secondly, they tend to be designed around specific applications, and are especially so designed in such a manner that the particular application per se dictates the architecture of the associated system and methodology. They have a strong singular focus. Linear-decision models, the conventional landscape, involve embedded data, in the sense that the applicable data structure is part of the decision-making architecture itself. This condition limits the possible outcomes of diagnosis and assessment behavior, and requires a significant overhaul of a system and of its associated methodology every time that new data is incorporated therein. Such linear-decision architecture, which essentially is a rule-based architecture, limits flexibility because of the fact that a user must follow certain designed pathways, even if those pathways are not optimal for the particular problem at hand.

The system and methodology of the present invention, as will be seen, overcome all of these limitations, and provide a functionally superior, non-rule-based, model of human-mimicking machine intelligence. In accordance with implementation and practice of core features of the present invention, data sets, including graphical data sets, are totally modular. Changes can be made in the applicable knowledge repository without disrupting the fundamental, available diagnostic and assessment processes in any way. This condition allows the system and methodology of this invention easily and readily to expand its fund of knowledge without any of the limitations that have restricted the scalability of previous, expert, artificial intelligence systems.

Basically, rules or knowledge-based systems, artificial intelligence systems, use ‘hard’ Boolean logic architectures. Such systems have utility but are hampered by their linearity and rigid knowledge structures—i.e. they contain data embedded within a process structure. To incorporate new data into such a structure requires a substantial re-write of the corresponding process, or processes. This becomes a large data-maintenance problem as complexity of a knowledge domain increases. Another limitation is that designers of such systems must anticipate all possible relationships within the relevant data set in order to field a reliable system. This can also be a limitation of classic neural network architectures.

Classic fuzzy logic, or Bayesian nodal systems, invariably depend upon statistical analysis, and numerous data propagation and maintenance issues are associated with such systems

By way of further contrast with prior art artificial intelligence technology, the system and method of the present invention can perform with a remarkably “human ability” to alter the direction being taken during a diagnosis and assessment operation based upon newly encountered data. Additionally, the system and methodology of the present invention offer the further advantages that the system and method: (a) essentially use natural-language text structure, coupled with stationary or motion graphics, to communicate with users, thus making extensive user training unnecessary; (b) can receive and process input data without any concern or requirement for defined-order input; (c) will consider all available data each time that there is a diagnostic “run” of the system; (d) can link diagnostic and assessment activities to documented medical research; and (e) can properly process both vague, minimal diagnoses and assessments, as well as detailed diagnoses and assessments.

From a text-based point of view, the functional building blocks of the method and apparatus of this invention take the form of elemental and fundamental, inferential components which are referred to herein as elemental data points (EDPs mentioned above herein). Two types of such textual EDPs are employed. One is referred to as a simple EDP, and the other as a complex EDP. A simple EDP consists of a singular data component, such as the word “shoulder” in a medically focused embodiment of the invention. A complex EDP consists of the associated combination of a single problem type, such as the word “pain” (in the medical field), and at least one data component, such as the word “shoulder” just mentioned. As will be more fully explained shortly, FIG. 2 in the drawings, still to be described herein, verbally diagrams the anatomies of these two kinds of EDPs. As will be developed in discussion presented below, at a certain point and region of operation of the present invention, these EDPs, when associated with elements called diagnostic-result-associated Master Keys and diagnostic Result Keys, also become associated with certain scalar values referred to herein as scalar addend values. Such addend values are directly associated with what we refer to as the predictive value contribution to a medical problem diagnosis/assessment. These addend values will be more fully described below in relation to the description of a diagnostic-result-associated Master Key.

These EDPs are lowest-common-denominator-type elements that relate to, and represent, a wide spectrum of characteristics (ultimately all that can be identified) which are relevant to the possibilities, variations and permutations of matters the domain of medicine. Put another way, each EDP permits no further relevant subdivision that will, during a diagnosis and assessment process, enhance the capability for further problem and/or situation differentiation. Methodology practiced in accordance with the invention is employed to generate and organize such EDPs, and also to produce another category of elements referred to herein, as mentioned above, as diagnostic Result Keys.

It should be noted at this point that the term EDP has just been described in the context of the text-based aspects of the present invention, this same term is also employed herein to refer to graphics-based data components, or elements, which can also be thought of as possessing inferential qualities.

A Result Key (diagnostic Result Key), according to the invention, is a collection of EDPs that represent a unique presentation of a diagnostic result that is known and documented, and which is assigned a particular degree, or level, of certainty (related to the scalar addend values mentioned earlier). Such a Result Key is thus a combination of EDPs that defines a reportable diagnostic result with some reliable degree of either positive or negative certainty.

Diagnostic Result Keys are effectively “organized” into identifiable diagnostic-result-associated Master Keys, where each such Master Key is effectively a collection of all EDP's that are associated with a single diagnostic result, and diagnostic Result Keys are identifiable collections of these EDPs which point, with different degrees of certainty, to that same diagnostic result.

Within each diagnostic-result-associated Master Key, the EDPs therein have a hierarchy which relates essentially to their respective predictive power values regarding the diagnostic result to which the Master Key relates (i.e., is associated). EDPs may range from having a high (or absolute) likelihood of predicting the correctness (positiveness) of that result, or to having a high (or absolute) likelihood of predicting the incorrectness (negativeness) of that same result. Those skilled in the art of medicine will fully understand, for each given diagnostic result, what the relative-relationship hierarchy is among the EDPs that are associated with the Master Key for that result.

The scalar addend values assigned to EDPs in a diagnostic result-associated Master Key are directly related to this hierarchy. They differ from one another in proportion to the relative differences of “positive and negative” result-predictive “powers” of the respective several EDPs in the Master Key. For example, an EDP(A) having a predictive power which points toward the positive correctness of a result which is twice that of another EDP(B) in the same Master Key, which other EDP also points toward the positive correctness of that same result, will be assigned a “positive” scalar addend numeric value which is twice that which assigned as a positive scalar addend numeric value to EDP(B). So, if the addend value given to EDP(B) is [50], that given to EDP(A) will be [100].

Similarly, different value levels of negative scalar addend numeric values will be proportioned and assigned to EDPs in the diagnostic-result-associated Master Key which point toward the incorrectness (negativeness) of the diagnostic result associated with that Master Key.

These scalar values are referred to herein as “addend” values because of the fact, as will be seen shortly, that they will be employed in mathematical “summing” calculations which are performed by the present invention.

A diagnosis or assessment herein, in either a textual sense or a graphics sense, or both, takes the form of a collection of EDPs, and it is such a diagnosis and assessment which, as will shortly be explained, is reviewed during practice of the invention to look for what are referred to herein as diagnostic Result Key hits.

Another important element of the knowledge domain of medicine is referred to herein as a “problem type”, or “medical problem type” (mentioned briefly above). As was stated earlier, so-called complex EDPs are made up of one or more data components grouped in the context of a problem type. A problem type is a distinct category of information, organized hierarchically for classifying a problem for the knowledge domain of medicine in a manner that mimics the way medically trained experts in that domain think of medical problems and situations (medical problem types). Ideally, the universe of medical problem types will be inclusive of all known problems within the domain of medicine. Problem types offer a convenient and effective entry point for users of the system and methodology of this invention for describing the problems and situations that they are wishing to have assessed. TABLE I below diagrams the relationships of EDPs, problem types, and data components:

TABLE I

| | Problem Type | Data Component |
|---|---|---|
| Simple EDP | n/a | Patient Age Band: 30-49 |
| Complex EDP | Pain | Location: Shoulder |
| | | Onset: Sudden |
| | | Frequency: Constant |

Associated with each EDP, in accordance with the invention, are two usage indicators which indicate whether the EDP (a) can be directly employed as part of a diagnostic Result Key, and/or (b) whether the EDP can be used as part of a reported medical diagnosis/assessment.

Table II immediately below generally shows how such indicators can exist:

TABLE II

| | RESULT | ASSESSMENT | |
|---|---|---|---|
| | USAGE | USAGE | |
| Type | INDICATOR | INDICATOR | SIGNIFICANCE |
| Classifications where | Y | Y | This would be considered a “normal” complex |
| the associated data | | | component. |
| components must be | | | |
| provided in the context | | | |
| of a problem type. | | | |
| | Y | N | This situation would be used to preserve a |
| | | | normalized view of complex components in order |
| | | | for the components to support shortcuts. |
| | N | Y | This represents complex data components that |
| | | | can be added to an assessment for documentation |
| | | | only, but are not considered by the adaptive |
| | | | knowledge engine. |
| | N | N | This is not a valid combination. |
| Classifications where a | Y | Y | This would be considered a “normal” simple |
| data component is | | | component. |
| complete without being | | | |
| defined in the context of | | | |
| a problem type | | | |
| | Y | N | This would be used to preserve a normalized view |
| | | | of simple components in order for the components |
| | | | to support shortcuts. |
| | N | Y | This would be used for simple components that |
| | | | can be added to an assessment for documentation |
| | | | only, but are not considered by the adaptive |
| | | | knowledge engine. |
| | N | N | This is not a valid combination. |
| Classification that | Y | Y | This is generally not a valid combination because |
| represent syndromes, | | | these highly granular components are only |
| which are single data | | | accessible via the refinement process of the |
| components that | | | adaptive knowledge engine. |
| represent a highly | | | |
| granular complex set of | | | |
| characteristics. | | | |
| | Y | N | This is the typical scenario for syndromes and |
| | | | other special simple components. This allows |
| | | | keys to be built for them yet their inclusion in an |
| | | | assessment is done outside the initial data capture |
| | | | process, with processes such as refinement, |
| | | | default components, etc. |
| | N | Y | This is not a common scenario, but could be used |
| | | | to capture highly granular data for documentation |
| | | | purposes only, without being considered by the |
| | | | adaptive knowledge engine. |
| | N | N | This is not a valid combination. |

The creation and use of such EDPs and Result diagnostic Keys enables a still further important feature of the invention which is that, during a diagnosis and assessment operation, the system and methodology of this invention can approach the task of arriving at a reportable diagnostic result by noticing the absence of some quality or characteristic that relates (a) to the original input inquiry data, and/or (b) to responses which are received from a user during what is more fully described below as a refinement process. For example, in the field of medicine, the absence of some particular characteristic of good health can indicate the impending emergence of some infirmity. As a consequence, the invention offers an impressive opportunity, in this field, to give very early warnings about the onsets of potential medical problems.

Importantly, the inferential, text-based and graphics-based database employed according to the invention is independent of the algorithm(s) employed by the knowledge engine during diagnosis and assessment activity. This independence strongly supports the open versatility with which the structure and methodology of the invention perform.

Still speaking from both text-based and graphics-based points of view, three of the many powerful aspects of the system and methodology of this invention are: (a) that inferential, elemental data components (text and graphics) are constructed to possess the characteristics and qualities mentioned above; (b) that an extremely important and new practice, referred to herein as relevance short-cutting (shortly to be described) fuels remarkable efficiency in diagnosis and assessment processing which is performed by the knowledge engine that is part of the system of the invention; and (c) that the practice of such short-cutting enables “lateral” investigations which cut across and embrace plural medical problem types—one of the most striking novel features of the present invention. This unique “lateral” capability, which involves, as just stated, not only the text-based behavior of the invention, but also the new and unique graphics-based behavior of the invention, especially models human cognitive thinking, and avoids the linear decision-making trap which confines the capabilities of conventional artificial intelligence systems and methods.

The process and practice of so-called short-cutting relates to how data components are handled according to the invention. A short-cut data component, also referred to herein as a normalized data component, is a single data component which is associated with one medical problem type, and which acts as a surrogate for relevant, plural, other data components (non-normalized data components) that are associated with the same medical problem type. Diagnostic and assessment relevance is the principal context within which short-cuts are created. As will be seen, relevance short-cuts, by creating and organizing related bodies of normalized and non-normalized data components, significantly enhance the performance of the structure and methodology of this invention.

A simple illustration given immediately herebelow, just in a textual context, will illustrate the concept of relevance short-cutting. This illustration is set in the context of a diagnosis and assessment operation wherein the user is entering information regarding the lateral orientation of a medical phenomenon/issue. EDP entry value choices include: Left Side; Right Side; Both Sides; One Side Only—a total of four EDP possibilities. Relevance short-cutting normalization of this nominally four-EDP population causes the “values” of “Left Side” and “Right Side” to be representable also as “One Side Only”. Hence, the two values “Left Side” and “Right Side”, which exists as definitive, plural individuals from a non-normalized point of view, are treated as the single, integrated value “One Side Only” from the normalized point of view. The importance of this multiple-to-singular short-cutting practice will be more fully discussed later herein. It is relevant to both the text-based and the graphics-based aspects of the invention.

A further important contribution of the present invention is that it employs statistical analysis, utilizing past system performances to enhance the confidence levels of medical diagnostic results produced in subsequent (downstream) diagnoses. During diagnostic activity, the system and method of this invention implement refinement sub-processes which thoughtfully elicit additional guided input information to help close in on the best obtainable medical diagnostic result. Data obtained during diagnostic performances are collected and stored in a manner whereby the knowledge engine in the system can perform statistical analysis to grow and improve the quality and effectiveness of the resident, underlying, database which fuels system behavior.

Expressed briefly here in terminology and phraseology which will become more well understood shortly, when, during a diagnosis and assessment process, a so-called diagnostic Result Key is “hit” so as to lead, at least preliminarily, to a reportable diagnostic result, EDP contents of the Result Key's associated diagnostic-result-associated Master Key are compared for content overlap with the EDP content in an associated collection of EDPs (this turns out to be a so-called EDP overlap), and the scalar addend values of the “overlapping EDPs” are employed in two mathematical sum calculations (one sum for positive addend values, and another sum for negative addend values) to arrive at what we refer to as a “power value, or values”. This power value offers significant worth in the practice of the invention.

In the context of the domain of medical knowledge, the context wherein the present invention focuses attention, each diagnostic-result-associated Master Key can be thought of as being associated with a different diagnosis to be reported as an outcome of diagnostic and assessment activity. As has been mentioned, each such Master Key effectively takes the form of a specific collection of EDPs. Given this situation, it is entirely possible, and frequently the case, that the very same EDPs which make up what has been referred to above as a diagnostic Result Key which is associated with a single specific diagnostic-result-associated Master Key, are also present in a very different diagnostic Result Key which is associated with a different diagnostic-result-associated Master Key.

Another important feature of the present improvement invention involves the fact that when a diagnostic Result Key “hit” occurs, the overlap comparison mentioned above is performed with respect to every diagnostic-result-associated Master Key which is linked with a diagnostic Result Key containing, and fully defined by, the same collection of EDPs as the diagnostic Result Key which initially generated such a hit. Through this approach, a reported medical diagnostic outcome provided by operation of the present invention takes on and demonstrates a very high degree of sophistication and accuracy. Having now, just above, described generally the important features of the present invention in relation principally, though not exclusively, to its text-based capabilities, we now note again with important emphasis that its companion, graphics-based capabilities substantially mirror, in the world of graphics, its text-based capabilities. Thus, included, as mentioned, in the system database, as part of the data-component content in that database, are graphics data components which are made available to the knowledge engine to place and utilize sophisticated graphics images on the user-interactive display-screen interface. These graphics components operate in a way which is parallel to, and like, the “operational way” of the text-based data components. They are functionally linked to relevant text-based components, and they function just as well with the unique concept of relevance short-cutting. They are highly intuitive to the trained medical mind, and they are presented appropriately on the mentioned display screen, with “sensitized” regions or locations that allow for data entry from and response to a user.

These graphics-based data components (a) include various appropriate details of the human anatomy, (b) can be presented with differing fields of view, (c) can be “zoomed” and enlarged as desired under either user or knowledge-engine control, can take the form of motion imagery, and can present different selectable human anatomical “systems”, such as the skeletal system, the blood-flow system, the muscular system, the nerve system, and so on. Their sensitized regions can be “user-addressed” by cursor control and “clicking”, by screen touching, by keyboard keys, or in any other conventional manner. These same sensitized regions function like the text-based EDPs mentioned above, and they are much more sophisticated than prior art, anatomical graphics displays because of their unique capabilities to function graphically, as just mentioned, like problem-type-related EPDs.

From the description of the present invention given herein, they (graphics-based data components) can easily be constructed by those skilled in the art for inclusion in a database, such as the database of the invention. Descriptions presented hereinbelow in the context of text-based system structure and performance should be understood to be substantially equally applicable to the graphics-based aspects of the invention.

These and many other features and advantages that are offered by the present invention improvement will become now more fully apparent as the detailed description which follows is read in conjunction with the accompanying drawings.

### DESCRIPTION OF THE DRAWINGS

FIG. 1 is a block/schematic diagram of both the preferred system of, and the preferred manner of practicing, the present invention.

FIG. 2 presents, in text form, the structures of the two fundamental types of data-component building blocks (EDPS) employed in and by the invention.

FIG. 3 diagrams the significant and important practice of relevance short-cutting which is implemented by the invention.

FIG. 4 illustrates, in text-enhanced, block/schematic, Bachman-diagram form, the important, adaptable data-component matrix (library) which contributes appreciably to the utility of the invention.

FIG. 5 illustrates, also in text-enhanced, block/schematic, Bachman-diagram form, the likewise important, adaptable diagnostic Result Key database (library) which co-functions with the component matrix in promoting the utility of the present invention.

FIGS. 6-9, inclusive, are Venn diagrams elaborating different, specific, illustrative diagnostic closures toward a medical diagnostic result as performed very fundamentally by the system and method of this invention. These figures illustrates foundation information regarding what is shown in FIGS. 11-15, inclusive, which FIGS. (11-15) schematically and graphically demonstrate certain mathematical calculations utilized in accordance with practice of the invention the present invention.

FIG. 10 is a block/schematic diagram illustrating fundamental performance of the invention from the point of view of entry of a single data component, and the operative relationships between this entry and the subject matters of diagnostic Results, diagnostic Result Keys, diagnostic-result-associated Master Keys, and Shortcutting.

FIGS. 11-15, inclusive, collectively illustrate the mathematical calculation improvements referred to earlier herein which are offered by the present invention.

FIGS. 16-21, inclusive, illustrate various different, static, sensitized, graphics-display-screen images which are representative of the graphics aspects of the present invention.

### DETAILED DESCRIPTION OF THE INVENTION

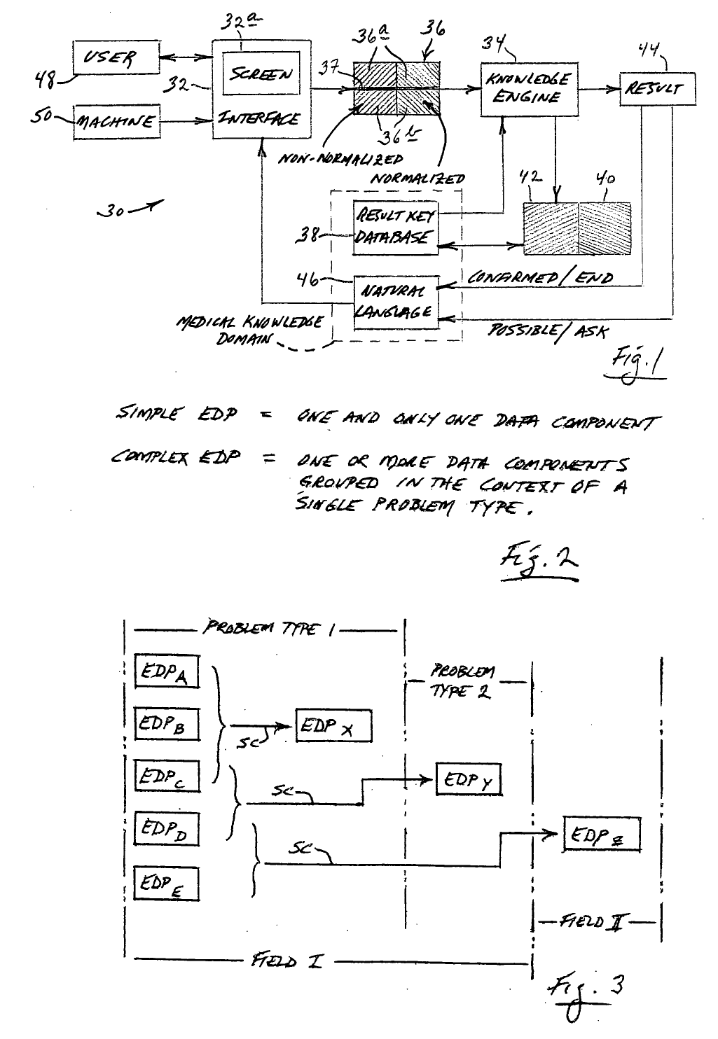

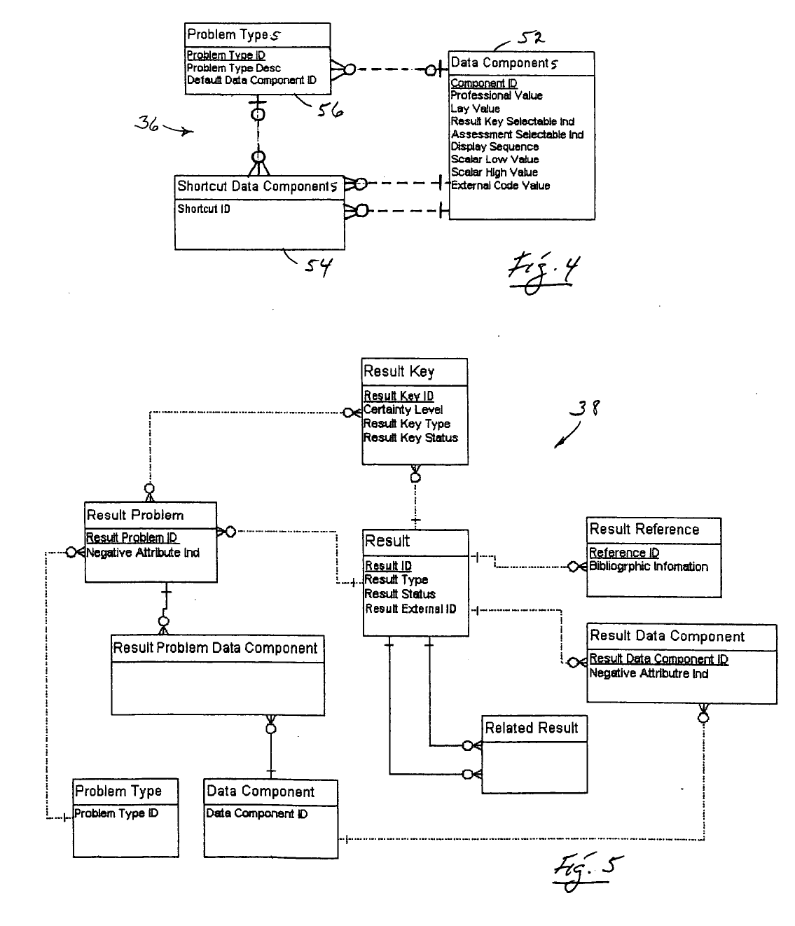

As is generally set forth above, FIGS. 1-10, inclusive, in the drawings describe underpinning fundamentals of the present invention, both in a text-based sense, and in a graphics-based sense

Indicated generally at 30 is a computer-based medical knowledge system (and methodology) which is (are) constructed and organized in accordance with the present invention to perform diagnoses and assessments (diagnosis/assessment process) regarding medical problems and/or situations. Much of the invention description which now follows will be presented from a systemic rather than a methodological point of view, and initially, for the most part, from a text-based point of view. These systemic and text-based points of view will be understood to function as a fully enabling disclosure and description of the related, implemented methodology of the invention, as well as of the graphics-based aspects of the invention.

Included in system 30 are a user-interactive, screen-display communication interface 32 with a screen 32a, also called an input/output communication interface zone, a computer-based, digital processing (digital computational) knowledge engine 34, a data-component matrix (or database or library or storage medium) 36, a diagnostic Result Key database (or library or storage medium) 38, a statistical analysis region 40, an engine-run database (or library or storage medium) 42, a diagnostic-result-assembling zone 44, and a natural-language output enabler 46. Components within blocks 36, 38 42 function collectively as what is referred to herein as an active diagnosis/assessment-accessible database. Interconnecting lines with arrowheads represent operative and communicative interconnections that exist, in accordance with the invention, between various ones of these several system and methodologic components. Screen 32a may conveniently be a touch-sensitive screen in interface 32, and/or this interface may include an appropriate cursor control device, such as a mouse, a keyboard, or something else.

At the left side of FIG. 1, two blocks, 48, 50 represent inputers of inquiry information that may be input the system in the context of requesting a diagnosis and regarding a problem and/or situation in the field of medicine. Block 48 specifically represents a human inquirer, and block 50 a machine (computer) inquirer. During system operation, both of these blocks, or only one of these blocks if only one is employed or involved, feed(s) input information directly into interface 32, and receives system-diagnostic-result output information directly from this interface. Description will continue herein in the context of the human input (48) of information, etc

Knowledge engine 34 in system 30 takes the form of a conventional digital computer appropriately equipped with algorithms (a) for implementing diagnoses based upon the contents of component matrix 36 and of diagnostic Result Key database 38 in relation to input information supplied to interface 32, (b) for conducting statistical analysis through cooperative interaction between blocks 40, 42, and (c) for implementing, via block 46, in a text-based manner, natural-language, outwardly-directed communication through interface 32 with, for example, user 48. As will be seen later in this discussion, it is engine 34, working with other blocks shown in FIG. 1, which performs the various mathematical calculation steps utilized in the practice and structure of the present invention.

Block 44 is organized to carry (along with engine 34) the responsibility, during diagnostic activity or at other times, and under the control of the knowledge engine, for determining whether a best-obtainable final diagnostic result has been achieved, and if not, what sort or sorts of refinement “questions” (both textual and graphical) ought to be directed through blocks 46, 32 to user 48. Such refinement behavior will be discussed more filly shortly.

The internal constructions of data-component database 36, and of diagnostic Result Key database 38, play key roles in enabling the human-cognitive behavioral capability of the system and methodology of this invention. These internal structures are detailed, respectively, in FIGS. 4 and 5 in the drawings, to which attention is now successively directed.

In FIG. 4, data-component database 36 is seen to be fully illustratable and describable with three, principal, interconnected blocks 52, 54, 56 which are labeled, respectively, “Data Components”, “Short-Cut Data Components”, and “Problem Types” (textual and graphical). FIG. 4 herein is presented in the format of a conventional Bachman-diagram which includes a collection of functional blocks, interconnected by lines that have different appearance characteristics, with certain well-known graphical symbols placed appropriately near the ends of these lines where the lines connect with the blocks.

These lines and symbols are familiar to those skilled in the art. Accordingly, a reading of FIG. 4, along with the labeled contents of blocks 52, 54, 56, will fully enable the creation and use, according to the invention, of data-component matrix 36. Text within blocks 52, 54, 56 describes the characteristics and attributes, generally, of the contents therewithin, and the following graphical and textual Table III, in a modest-content way, further illustrates component matrix 36.

TABLE III
Medical Diagnosis

```
Problem Types:
    Pain
    Rash
    Mass or Lump
Data Classifications/data Components:
    Onset
        Sudden
        Gradual
    Pain Characteristic
        Sharp
        Dull
        Colic
        Burning
    Color
        Red
        Tan
        Black
```

Focusing attention now on FIG. 3 along with FIGS. 1 and 4 and TABLE III, the nature of a short-cut, as proposed by the present invention, is illustrated graphically and in text in FIG. 3. As was mentioned briefly earlier, short-cuts employ the characteristic of relevance to associate a plurality of broad-based EDPs (or graphics components), which are associated with one common medical problem type within the medical-knowledge domain, typically with another singular EDP. This “other” EDP can be associated (a) either with the same common problem type in the medical-knowledge domain, or (b) with another problem type in the same knowledge domain. This special “other problem type” quality of a short-cut is what allows for significant lateral-diagnosis processing in a manner which is very closely linked to normal human thinking. It is one key feature which distinguishes the structure and methodology of this invention from conventional, “linear” artificial-intelligence structures and procedures. It is a feature which adds important flexibility, mobility, agility and efficiency to the performance and capability of the present invention.

Looking especially now to FIG. 1, database 36 includes both text-based and graphics-based data components, as discussed earlier herein. A dark horizontal line 37 is used to indicate that the upper portion of database 36 in FIG. 1 contains text data components 36a, and the lower portion contains static and/ or motion graphics data components 36b. Data components on the left side of database 36 in FIG. 1 are non-normalized data components, and those on the right side of database 36 in this figure are normalized data components. Here, one will observe that the “user side” of database 36 “sees” the entire, large volume of non-normalized data components, or EDPs, such as non-normalized text-based and graphics-based data components. This is important, inter alia, in allowing for a very high degree of unconstrained, free-form and free-flowing “dialog” between the system of this invention and a user. It prevents the significant conventional drawback, associated with known artificial intelligence systems, of early locking, channeling, and inflexible linearizing, of problem and situation diagnoses and assessments.

On the other hand, however, the “knowledge-engine side” of matrix 36 sees only the smaller, most relevant set of normalized data components, as determined through the above-described process of short-cutting. Engine operating efficiency benefits significantly from this situation.

Shifting attention now to FIGS. 1 and 5 together, FIG. 5 details, as was mentioned earlier, the structure of diagnostic Result Key database 38. As is the case for previously described FIG. 4, FIG. 5 is, in its general layout, a conventional Bachman-diagram. This Bachman-diagram, along with the text material provided in it, fully describes to those skilled in the art the make-up and functionality of database 38. Accordingly, no further special elaboration of this database is deemed necessary.

As was noted earlier, still another important and significant offering of the present invention is its unique cooperative utilization of the “worlds” of both inference and statistics. This world is brought together in the special interactive behavior which takes place between knowledge engine 34, diagnostic Result Key database 38, and blocks 40, 42.

Each time that engine 34 runs a diagnosis/assessment process (still to be described), its diagnostic performance results, including the EDPs and the diagnostic Result Keys employed, are recorded and stored in block 42, the “engine-run” database. It is with regard to this performance-recorded, engine-run data that statistical analysis, and special mathematical calculations are conducted.

At any appropriate interval, such as at the completion of each diagnostic “performance”, or after a certain number of completed diagnoses, or completely at user selection and invocation, for several examples, engine 34, database 42, and statistical analysis region 40 cooperate to review stored performance data, and to analyze it to determine if any of several different kinds of diagnostic Result Key modifications are in order. Statistical analysis region 40 may conveniently take the form of appropriate statistical-analysis software which is resident in knowledge engine 34, and which may be designed in a conventional manner to review stored diagnostic-performance data. For example, such data may be reviewed, based upon previously determined diagnostic results, to assess whether a particular diagnostic Result Key's EDP content should be changed (enlarged, reduced, etc.), whether that Result Key's level of certainty as to its correctness should be changed, whether the Result Key should be eliminated, and so on. Such changes are “reported” to diagnostic Result Key database 38, and thus may change the content of this database if such is an appropriate event. System 30 conveniently, and perhaps preferably, asks “permission” to invoke any such diagnostic Result Key database revision. In this manner, the system and methodology of this invention continually self-improve to become more agile, effective and quickly accurate, much in the same way, at least in part, that the human mind adapts and grows from experience.

By utilizing statistical analysis in this helpful manner, the system and methodology of the invention uniquely integrate the management advantages of such analysis with the power and versatility of the inferential databases (EDPs) which form the data-component database and the diagnostic Result Key database. Coupled with the innovation of relevance short-cutting, the invention clearly cleverly mimics significant aspects of normal human cognitive thinking.

The inferential underpinning of these two databases offers an approach landscape to medical problem and situation diagnosis and assessment which is wide, rich, and common to normal avenues of reflective thinking. Short-cutting which can include relevance pointers to EDPs in the same or different medical problem areas, prevents the constricting kind of linearization which characterizes conventional, machine, artificial-intelligence mannerisms. Such short-cutting also presents, or tends to present, to the knowledge engine for processing the most relevant and smallest-size set possible of foundation inferential data. With these databases clearly disconnected committedly from the underpinning processing algorithm(s), extensive flexibility and medical problem and situation evaluation are definitively offered and made present by the practice and implementation of the methodology and system of this invention. Reportable diagnostic results, based upon inferentially founded result-keys which are assemblages of different EDPs (and EDP-associated), are reviewable and modifiable under the thoughtful and watchful eyes of statistical analysis, and are subjected to certain mathematical processes (still to be described grow progressively more accurate and sure with time.

Completing a description of what is shown in FIG. 1, attention is directed to blocks 34, 44 and 46.

Block 34, the knowledge engine, takes the form of a programmable digital computer, as was mentioned earlier, which is, inter alia, programmed to perform diagnoses and the mathematical calculations generally mentioned above, to report diagnostic results, and, as just stated above, to aid in the statistical analysis of recorded diagnosis-performance data. It is also suitably programmed to perform focusing refinements regarding the inputting of data by, for example, a human user 48. And so, for example, if no confirmed, reportable diagnostic result occurs during one run of diagnostic behavior, the knowledge engine utilizes block 44 to direct a set of specific, multiple-choice (or graphics-based) questions (see the line marked “POSSIBLE/ASK” in FIG. 1) to the user, requesting, effectively, additional input information. These questions are specifically related to the status of diagnosis processing which has so far been undertaken. This is the important refinement process mentioned earlier. Block 46 assures that these questions are presented to a user in intuitive natural language, or in intuitive graphical imagery displays.

During the performance of a diagnostic procedure, and in relation, generally speaking, to EDP data which is provided by a user graphically or in text form, knowledge engine 34 operates in accordance with the following basic “algorithmic instructions”. How the performance of these fundamental instructions is modified to accommodate the earlier-mentioned mathematical determinations will be described later.

Database 36 and block 44 collectively are referred to herein as intermediary structure, and block 44 is referred to as diagnosis/assessment-refinement capability substructure.

### The Algorithm

A diagnosis/assessment (Aₓ) consists of one to many EDPs, and can be thought of as a set:
Aₓ={EDP₁, EDP₂, . . . EDPₙ}
Each diagnostic result key (in this case, RKₓ) consists of one to many EDPs, and can also be thought of as a set:
RKₓ={EDP₁, EDP₂, . . . EDPₙ}
The adaptive knowledge engine returns a diagnostic result (a positive ruling-in) when the following formula is true:
Aₓ INTERSECT RKₓ=RKₓ
Simply stated, if the set of EDPs that comprise a diagnostic Result Key are found within the EDPs that comprise the diagnosis, then the result corresponding to the Result Key would be returned. It is important to note that the EDPs do not have to be identical to satisfy a diagnostic Result Key hit. The critical factor is that each EDP that is part of a diagnostic Result Key must either equal an EDP in the diagnosis or be contained within an EDP in the diagnosis (a subset).
The intersection of a diagnostic Result Key's EDP with a diagnosis' EDP must occur within a single EDP: It cannot span EDPs.
The result is considered negative (contraindicated—a positive ruling-out) if the following is true, when MKNx represents the set of EDPs comprising the master for result “x” that are contraindicated:
Ax INTERSECT MKNx=0 (Empty set).

As will become more fully apparent shortly, the knowledge engine of this invention, practicing the mathematical calculation functionality mentioned above, can return a diagnostic result which is either positive (yes, a certain medical condition probably, or definitely, exists), or negative (no, a certain medical condition probably, or definitely, does not exist). At the beginning of what can be thought of as each diagnostic procedure, or operation, (diagnosis/assessment process), wherein a diagnostic result determination is to be assessed/evaluated, a “beginning diagnosis” in the procedure is referred to herein as a preliminary, pre-reportable, result-associated diagnosis. This preliminary diagnosis lies “along the way”, so-to-speak, toward the creation of what is called a “reportable diagnosis”.

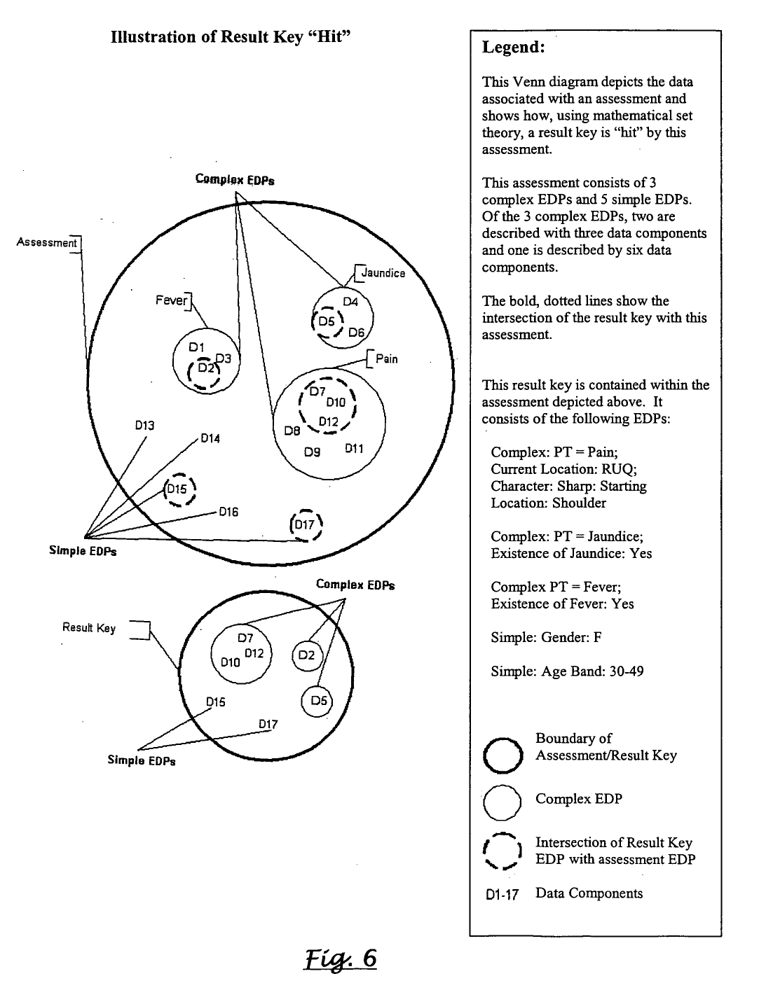

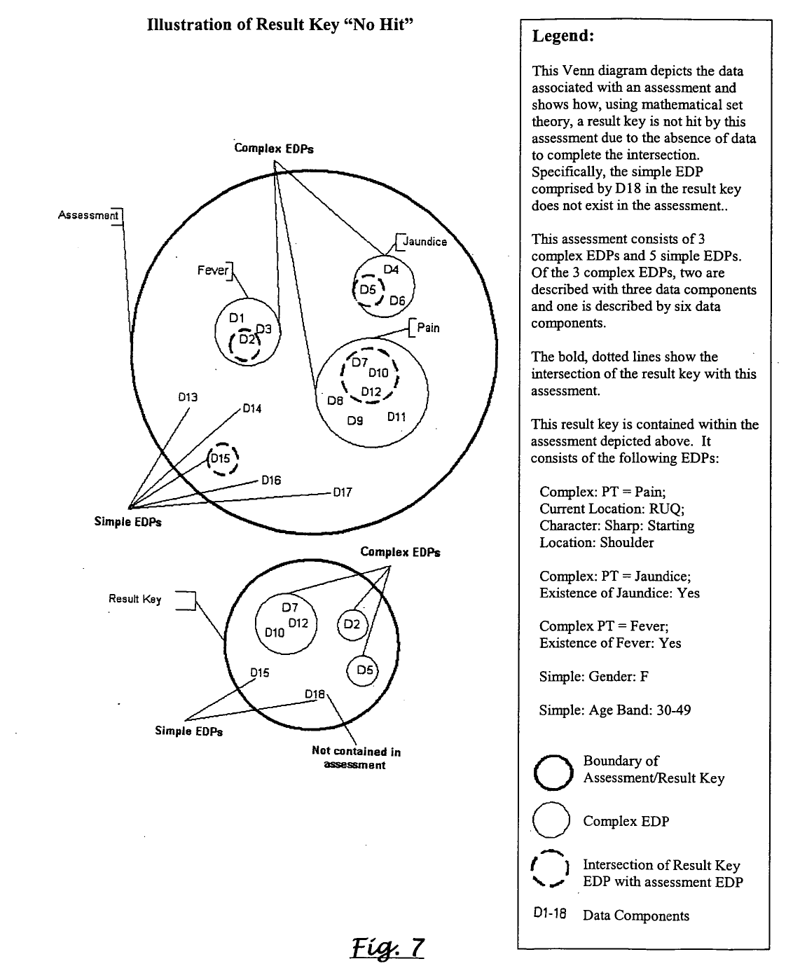

Continuing now with what is further shown in certain ones of the drawings, the four diagrams which make up FIG. 6-9, inclusive, are, as has already been mentioned, conventional Venn diagrams. To those generally skilled in the art, they are very self-explanatory regarding how the knowledge engine performs the above-described basic algorithm of the present invention. In particular, those who are skilled in the art will readily understand clearly from these illustrative performance diagrams just how knowledge engine 34 fundamentally performs a diagnosis during its operation, under several, different, typically encounterable diagnostic situations.

By way of brief summary, the four examples that are set forth in these four figures, furnished at this point without reference to the still to be discussed mathematical requirements proposed by the present invention, are based on a series of related medical diagnoses which involve, for illustration purposes, three complex EDPs and five simple EDPs. In the first example (FIG. 6), a diagnostic Result Key is depicted which gets a “hit” on this diagnosis. Such a Result Key consists of EDPs that represent the following scenario:

A female patient, age 30-49, inclusive, is experiencing sharp pain in the right upper quadrant that originated in the shoulder. This same patient is also experiencing fever and jaundice.

The diagnostic Result Key is “hit” in this example because all of its EDPs are each completely contained within a single EDP in the overall diagnosis.

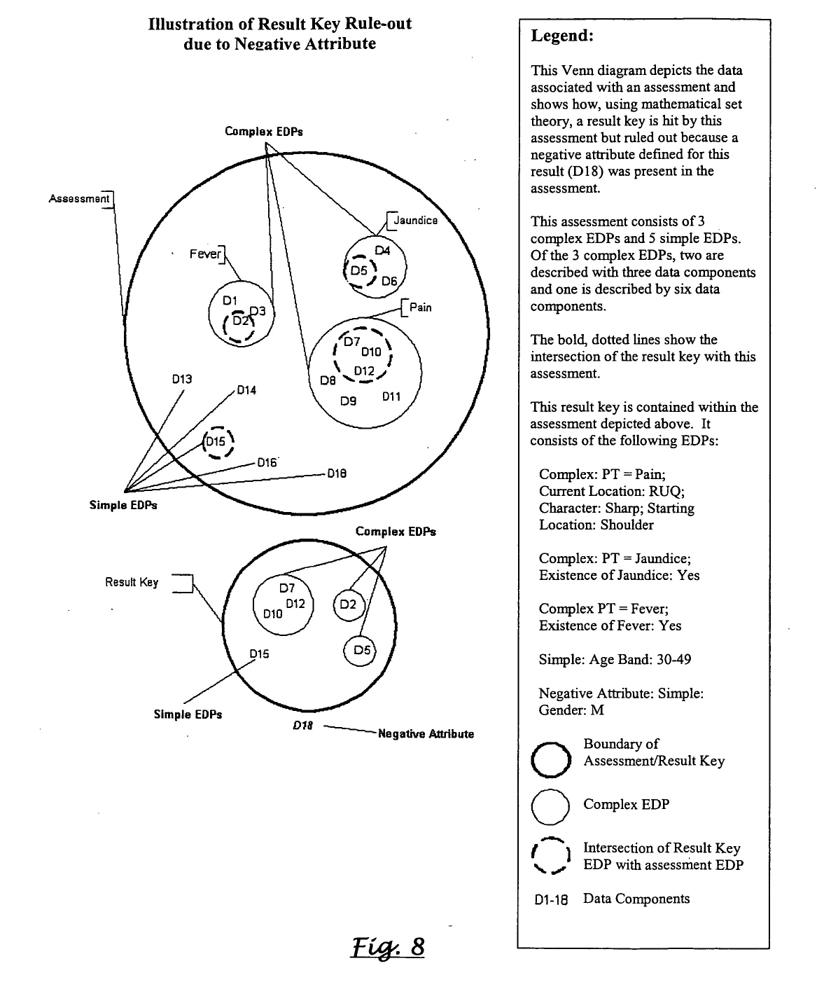

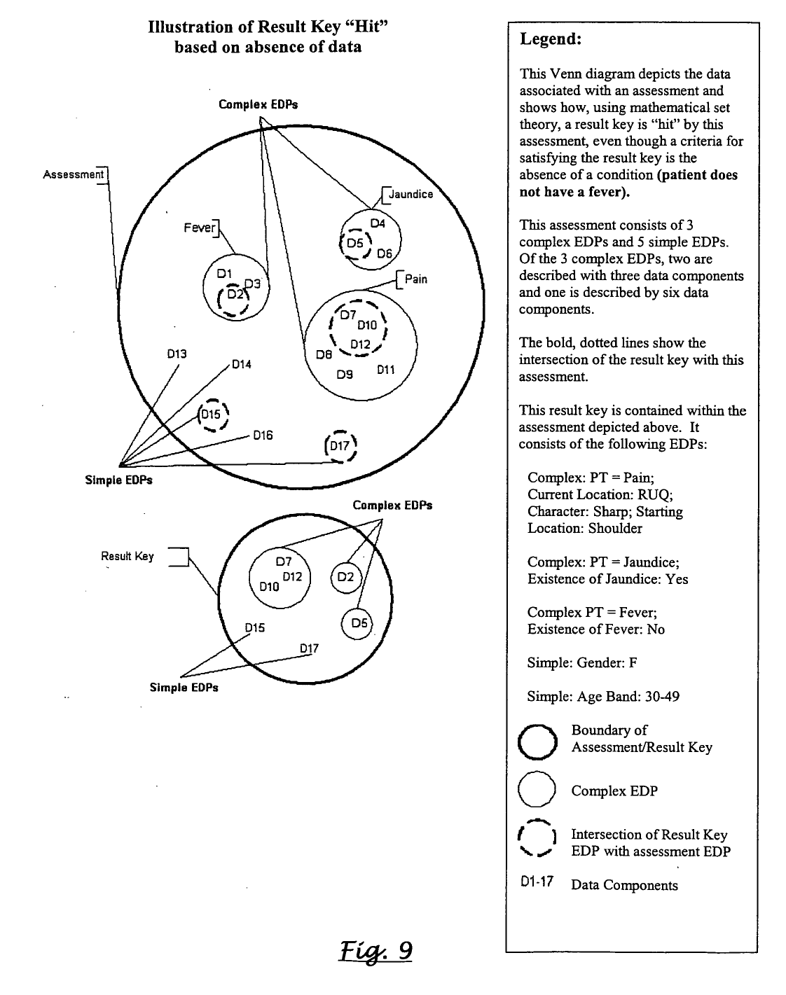

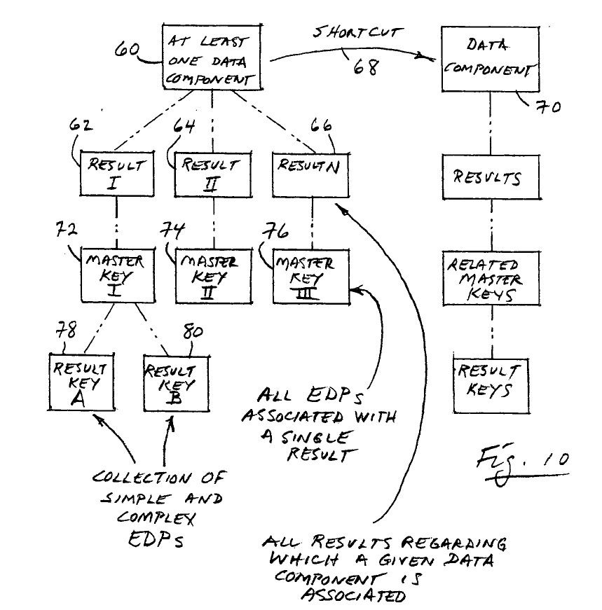

Regarding the other three examples, the second example (FIG. 7) illustrates a situation where a diagnostic Result Key is not hit. The third example FIG. 8) pictures a case where a diagnostic result is ruled out due to the existence of a negative attribute which has been presented and detected. The fourth example (FIG. 9) illustrates a “hit” on a diagnostic Result Key under circumstances where one EDP in that Result Key represents the absence of a particular medical problem-type condition.

The process of diagnosis refinement mentioned above is now described in relation to Table IV. This process of the adaptive knowledge engine can be engaged during diagnostic performance to lead the user to the final results (such as a reportable result-associated diagnosis) by performing and analysis of the data already captured by the diagnosis and the possible results based on that data.

The refinement process generates a series of candidate standardized data lists that are organized and presented to the user. The user can add or subtract any data points to/from the diagnosis, and can resubmit the diagnosis to the engine.

The candidate data lists generated by the adaptive knowledge engine consist of data points that perform one of two functions:
1. Help confirm a possible result that the engine has identified.
2. Rule out a possible result based by identifying data that is contraindicated.

A run of the AKE (engine 34) will yield the following:
1. Zero to many specific results.
2. Zero to many general category results.
3. One or more potential results organized in what is called a “result map”.

For each diagnostic result known to the engine, there are three ways that refinement data can be generated for those results by the engine. These are:
1. Data points that would result in the satisfaction of a general category key for the result.
2. Data points that would result in the satisfaction of a high probability key or confirmed existence key for the result.
3. Data points that would contraindicate the result.

Each result known to the AKE may have one or more “related results” that share data points with the subject result and which may be mistaken therefor. By identifying combinations of the types of results yielded by an engine run along with refinement information, one can discover the best refinement algorithms to produce diagnosis refinement questions. Table IV illustrates such combinations and resulting algorithms.

TABLE IV

| | Output of AKE | | |
|---|---|---|---|
| | | General Category | |
| Data Points | Specific Results | Results | Potential Results |
| Ones that satisfy a | Refinement Algorithm 1: | Refinement Algorithm 2: | Refinement Algorithm 3: |
| general category key | Identify all EDPs for all | Identify all EDPs for all | Identify all EDPs for all |
| | related results (to a | related results (to a | potential results that |
| | specific result that was | general category result | participate in a general |
| | returned by the engine) | that was returned by the | category key for that |
| | that participate in a | engine) that participate | result. |
| | general category key. | in a general category | |
| | | key. | |
| Ones that satisfy a | Refinement Algorithm 4: | Refinement Algorithm 5: | Refinement Algorithm 6: |
| high probability key | Identify all EDPs for all | Identify all EDPs for all | Identify all EDPs for all |
| | related results (to a | related results (to a | potential results that |
| | specific result that was | general category result | participate in a high |
| | returned by the engine) | that was returned by the | probability key for that |
| | that participate in a high | engine) that participate | result. |
| | probability key. | in a high probability key. | |
| Ones that | Refinement Algorithm 7: | Refinement Algorithm 8: | Refinement Algorithm 9: |
| contraindicate the | Identify all EDPs for all | Identify all EDPs for all | Identify all EDPs for all |
| result. | related results (to a | related results (to a | potential results that |
| | specific result that was | general category result | contraindicate those |
| | returned by the engine) | that was returned by the | results. |
| | that are contraindicated. | engine) that are | |
| | Refinement Algorithm | contraindicated. | |
| | 10: Identify all EDP for | | |
| | each specific result | | |
| | returned that would | | |
| | contraindicate that | | |
| | result. | | |

If, due to insufficient data capture, the engine does not generate results, refinement cannot be invoked.

The results of refinement are organized by problem type for logical consideration.

When refinement is invoked, any or all of the refinement algorithms may be invoked. Which algorithms are invoked is a function of (1) the number and type of results generated for the diagnosis at the point refinement is invoked, and (2) how the AKE is configured for the subject area. Some types of refinement may not apply to some subject areas.

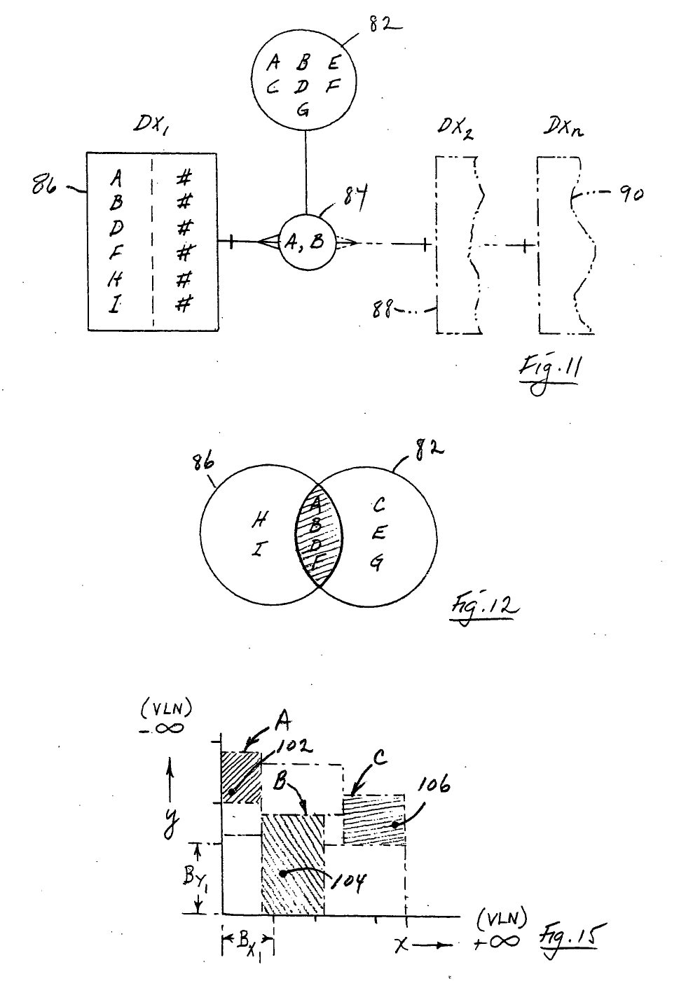

Reviewing generally the overall methodology of the present invention described so far, and fundamentally in accordance with the pre-improvement version of this invention, and doing so in light of the systemic description which has largely occupied the text above, while different designers of a system and a methodology made in accordance with this invention might, and may, chose different starting approaches to making a diagnosis, one suitable approach in the context of the described medical-problem-domain system, involves asking a user, as an opening question, for example, to identify, via the introduced data, the (or a) specific medical problem type which is associated with the medical problem and/or situation that has prompted the user to invoke system diagnosis in the first place. FIG. 10 generally illustrates what occurs when a response to such an opening question takes the form of one of the simplest possible replies, such as a single data-component reply, like “existence of pain”, without more. Even the presence of a single, user-introduced EDP data-component (textual or graphical), which becomes reviewed by the system of the invention, can form what has been referred to above as a preliminary, pre-reportable, result-associated diagnosis, en route, so-to-speak, through the launch of a diagnostic procedure, to the creation of a final, reportable, result-associated diagnosis.

After receipt of the “existence of pain” input response (Block 60 in FIG. 10) which response takes the form of a simple EDP, the computing structure of the invention makes an appropriate survey of the database content to identify all diagnostic results “known” to the system to which the data component “existence of pain” relates (Blocks 62, 64, 66 in FIG. 10). The system thus responds to this simple, single-data-component response with an expansive review and “look” at the entire database of diagnostic results. The system simultaneously responds (Line 68 in FIG. 10) to any relevant shortcutting which is associated with the “existence of pain” response, and if shortcutting exists, identifies one or more other data components (A) (Block 70 in FIG. 10) with respect to which it performs the same kind of expansive look (or looks) at its results database as was just described for the single input data component.

What next occurs, with respect to all diagnostic results that have been identified by the process outlined above, is that the diagnostic-result-associated Master Key for each such diagnostic result (Blocks 72, 74, 76) is examined with regard to its content which includes all EDPs that are associated with the particular diagnostic result, organized, effectively, into different diagnostic Result Keys (see Blocks 78, 80 that are associated with the diagnostic-result-associated Master Key represented by Block 72). Each such Result Key is a collection of EDPs which has been determined to point, with a particular degree of certainty, to the associated diagnostic result.

When, after system Result-Key looking takes place, a diagnostic Result Key is “hit” (see FIGS. 6 and 9), a diagnostic report, along with any determined requests for refinement, are reported through block 32 (see FIG. 1) to the user.

From the above-given description of the present invention, considered along with the drawings, the system database can be seen to be organized, by relevance short-cutting, and at least in part, into bodies of (a) normalized and (b) non-normalized data components (text and graphic). Such non-normalized data components are effectively further organized into different medical-problem-specific groups of data components, all data-component contents of which are linked by relevance short-cutting to a common, normalized data component (see especially FIGS. 3 and 10 which directly illustrate this important organizational feature of the invention, and from which the just-stated specification text is directly readable). It is this important short-cutting feature of the invention which, as expressed earlier herein, fuels the unique diagnosis and assessment-processing efficiency of the system by establishing normalized data components through which diagnostic and assessment linkages may be made to a plurality of possible, different medical problem types within the knowledge domain of medicine, regardless of the specific medical-problem-type “nature” of particular user-entered data.

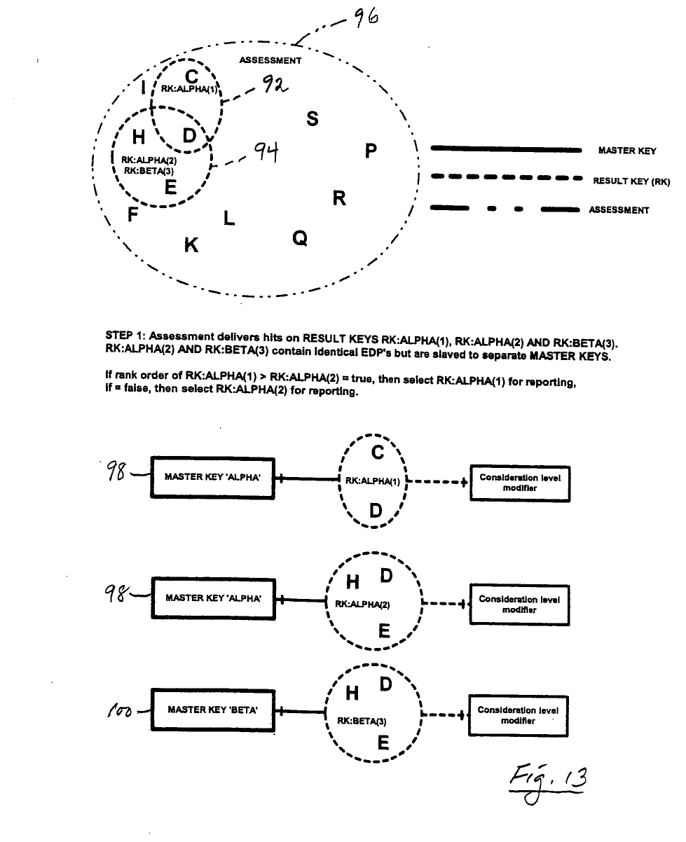

Turning focused attention now toward the mathematical-calculation functionality mentioned above, and offered specifically by the present invention, this will be described with particular reference made to different ones of FIGS. 11-15, inclusive, viewed along, as appropriate, with FIGS. 1-10, inclusive.

Beginning with FIGS. 11 and 12, indicated generally at 82 in FIG. 11 is what is referred to herein as a diagnosis or assessment containing seven EDPs A, B, C, D, E, F and G. Through processing performed in accordance with the description of the invention given above herein, a diagnostic Result Key 84 has been “hit”—this Result Key including EDPs A and B.

Shown at DX₁, DX₂ and DX_{N}, numbered 86, 88, 90, respectively, in FIG. 11, are three different diagnostic-result-associated Master Keys. The letters DX_{N} refer specifically to diagnoses which are relevant to the knowledge domain of medicine. Diagnostic Result Key 84 is essentially slaved to diagnostic-result-associated Master Key 86, but it turns out that its EDPs, A and B, are also EDPs which make up two, specific, different diagnostic Result Keys, one each for the two diagnostic-result-associated Master Keys 88 and 90. In other words, the EDPs which make up Result Key 84 also define specific, different Result Keys that are within the EDP contents respectively of Master Keys 88 and 90.

Thus, and in accordance with practice of the invention, the mathematical calculation mentioned above is performed, as will now be described specifically for Master Key 86, also with respect to Master Keys 88 and 90. A more specific illustration of this multiple Master Key situation will be described a bit later herein with respect to what is shown in FIGS. 13, 14 and 15.

Because of the fact that diagnostic Result Key 84 has hit diagnosis 82, and is specifically slaved to diagnostic-result-associated Master Key 86, an overlap comparison is performed to find the region of “EDP overlap” which describes the relationship between diagnosis 82 and Master Key 86. It should be noted that positioned within the block in FIG. 12 which represents Master Key 86, and disposed to the right of each of the six EDPs A, B, D, F, G and H which make up this diagnostic-result-associated Master Key, there is a number symbol (#). This symbol reflects the “presence” of certain positive or negative integer values which are associated as the mentioned scalar EDP addends assigned, respectively, to each of the EDPs in Master Key 86. These scalar number values are the ones which, as will shortly be seen, are involved in what has been referred to herein as a pair of sum/sum mathematical calculations that are employed to improve the diagnostic reporting capability and sophistication of the present invention.

With respect to performing an overlap comparison, or function, in relation to diagnosis 82 and Master Key 86, this is illustrated graphically in FIG. 12 where one sees two overlapping circles which are given reference numbers 82, 86 to indicate that they represent, respectively, diagnosis 82 and Master Key 86. Within each circle the letter designators for the respectively contained EDPs appear, and the region of overlap is shaded in the center of FIG. 12, and seen to include an overlap of EDPs A, B, D and F.

With these four “overlapping” EDPs identified, one then looks to the EDP addend scalar values in Master Key 86, and thereafter, the mentioned sum/sum calculations are performed, one for all of those particular values of A, B, D and F which are positive, and one for all of those particular A, B, D and F values which are negative. The sum/sum calculations are shown generically and immediately below in the two stated equations which generate power value components X (for positive numbers) and Y (for negative numbers):
ΣEDP(+Addends)=X
ΣEDP(−Addends)=Y

These calculated sum/sum values for X and Y are referred to herein as the determined power values associated with the particular diagnostic result which is associated with diagnostic Result Key 84. It is these power values which basically define the level of certainty with respect to which a diagnosis report, for example, reporting DX₁ as associated with Result Key 84, will be regarded.

Each diagnostic Result Key, such as Result Key 84, also has associated with it, or may have associated with it, something which is referred to herein as a qualitative consideration modifier, such as the phrase “extremely rare disease”. In terms of putting out a diagnosis report (reportable diagnosis) which reports the diagnostic result associated with Result Key 84, the certainty level is reported in relation to the power value (sum/sum) calculations which have been made. If any consideration modifier exists, such as the one just mentioned above, that modifier is also applied to the relevant diagnostic report.

The same calculation procedure just described with respect to looking at the region of EDP overlap between diagnosis 82 and Master Key 86 is performed also to look at the respective overlaps in EDPs which exist between diagnosis 82 and Master Keys 88, 90, respectively. Power values are calculated with respect to these overlap comparisons, and from the plurality of calculations, if such are performed with respect to a particular set of EDPs involved in a Result Key hit, an appropriate output report of a diagnosis is provided, with statements included that relate to the results of these calculations characterized, if applicable, by any appropriate Result Key qualitative consideration modifier.

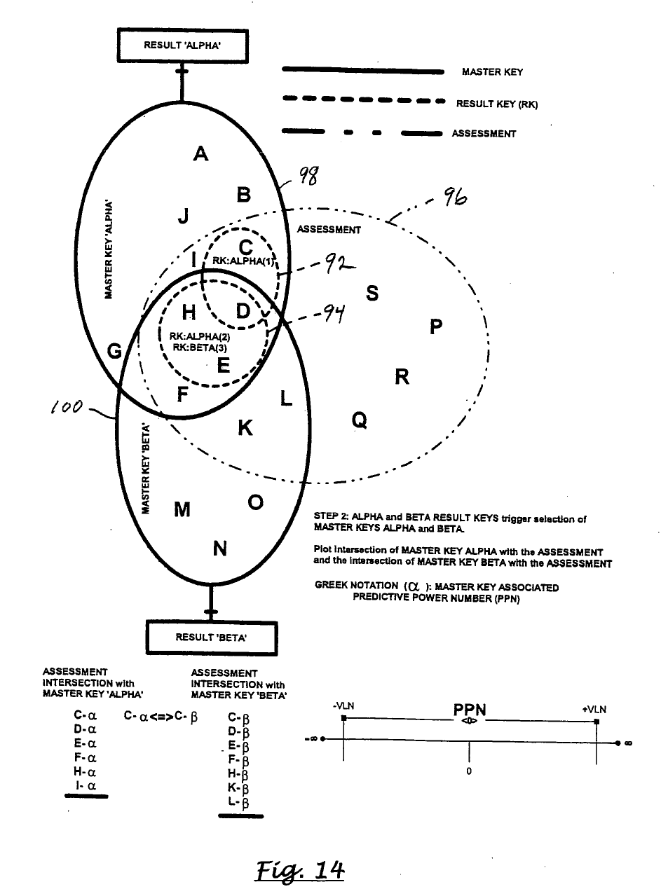

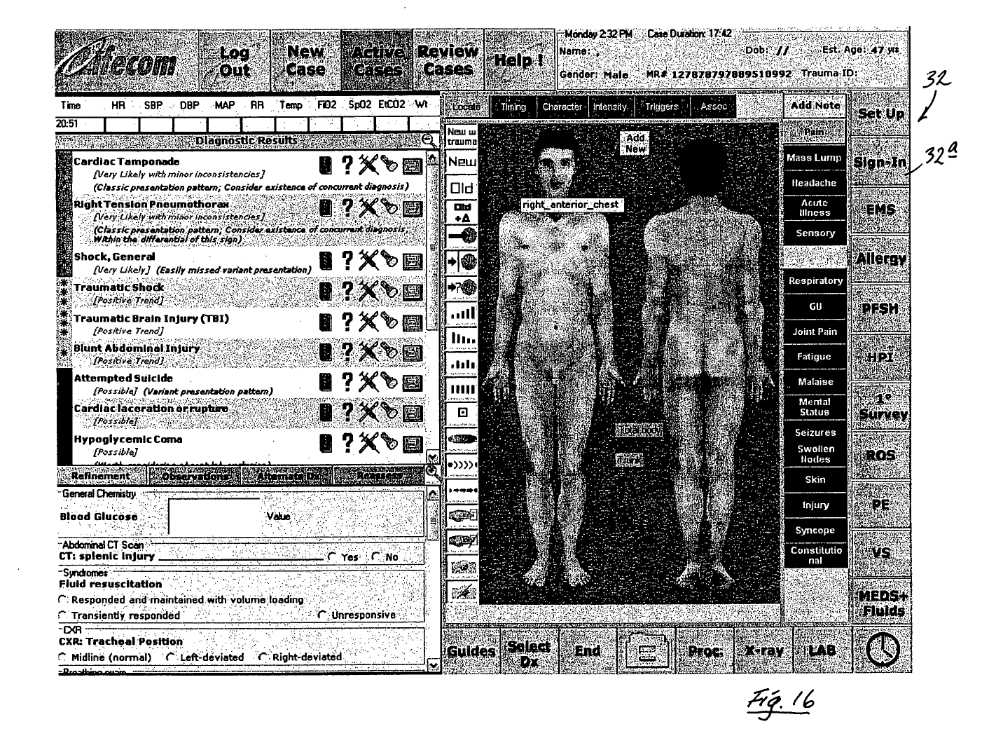

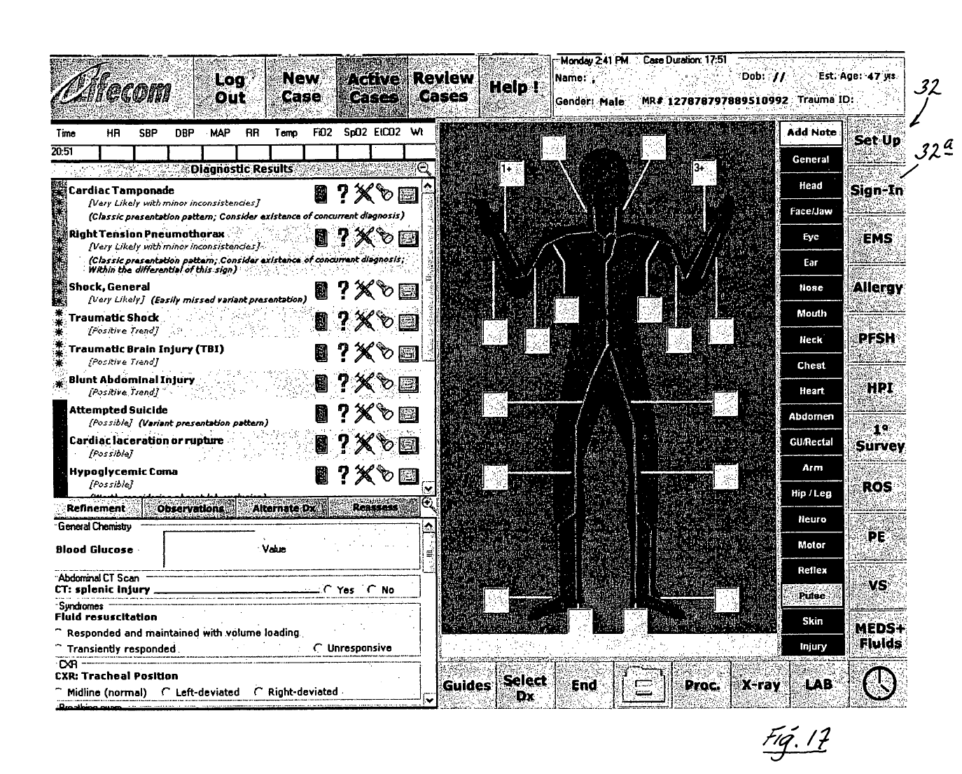

FIGS. 13 and 14, with a considerably greater level of detail, and in a quite self-explanatory way, illustrate two diagnostic Result Key hits 92, 94 that are associated with a particular diagnosis 96. Diagnostic Result Key 92 containing EDPs C and D is a singularity, in the sense that it is associated with only one diagnostic-result-associated Master Key shown generally at 98. Diagnostic Result Key 94, however, which contains EDPs H, D and E, in fact defines two different diagnostic Result Keys, one of which is associated with just-mentioned Master Key 98, and the other one of which is associated with another diagnostic-result-associated Master Key 100. The overlap comparisons which are performed here are clearly illustrated graphically in FIG. 14 between diagnosis 96 and Master Key 98, and between diagnosis 96 and Master Key 100. At the lower left corner in FIG. 15, the respective sets of EDPs contained in the two Master Keys 98, 100, also referred to herein as diagnostic-result-associated Master Key “Alpha” and diagnostic-result-associated Master Key “Beta”, respectfully, are pictured set next to α and β Greek characters. These characters represent the addend scalar values which are associated with those respective EDPs in each of the two different diagnostic-result-associated Master Keys.

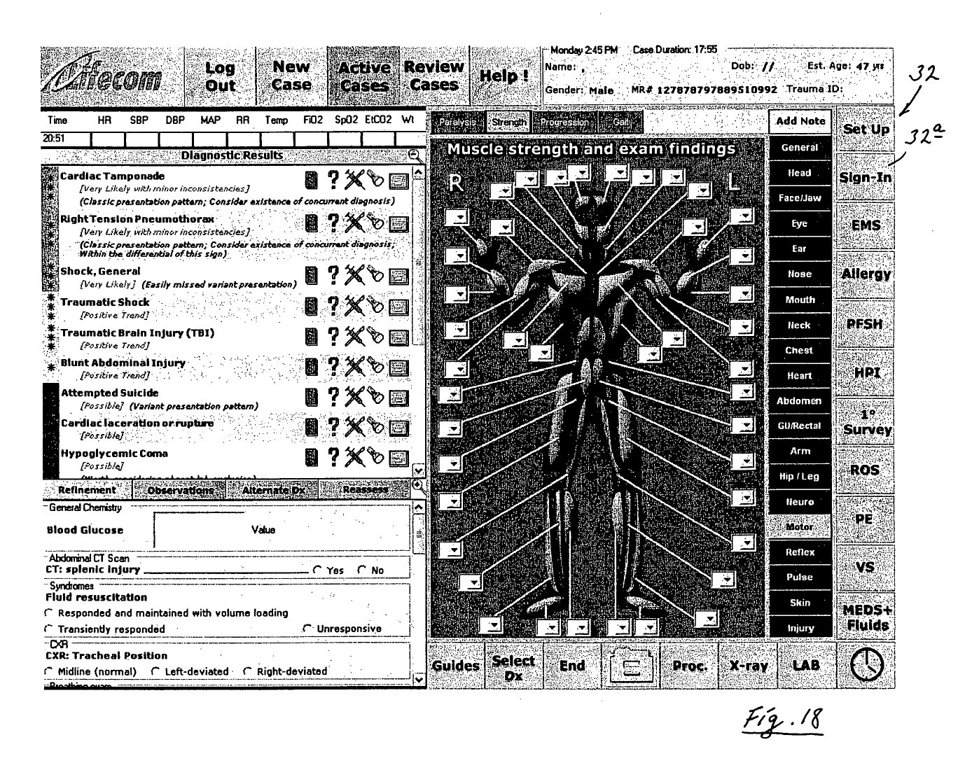

Sum/sum calculations as described above are performed, and X and Y power-value results therefrom, are plotted for the three conditions illustrated in FIGS. 14 and 15, with these three power-value-calculated results pictured as three darkened dots 102, 104, 106 that appear on an X, Y orthogonal graph shown in FIG. 16.

Taking a look at FIG. 15, one will note the presence therein of three differently-sized, shaded rectangles A, B, and C, with rectangle A having a side which is coincident with the Y axis, rectangle B having a side which is coincident with the X axis, and rectangle C being completely spaced from the X and Y axes. The three darkened dots 102, 104, 106 just mentioned, as can be seen, reside within these three shaded rectangles A, B, C, respectively. Other rectangles which are present, as illustrated in FIG. 16, are outlined suggestively only by dash-dot lines, and are not shaded.

Each of these rectangles is referred to herein as a consideration level which will be used to characterize reported diagnoses whose associated sum/sum calculations produce data points that “land” within these rectangles. In other words, all power values calculated by the sum/sum procedure described above which fall within rectangle A are treated as being reportable to have the same consideration level with regard to presenting information to a user in a reportable and reported diagnosis.

In FIG. 15 since the three mentioned blackened-dot data points fall within regions having different associated consideration levels, in a reported diagnosis, all three of these conditions will form portions of that diagnostic report. The user who has activated the system and methodology of this invention to generate that reportable diagnosis will make a judgment about how to treat, interpret and understand the reported diagnostic results.

Shaded rectangles A and B, each of which has one side coincident with one of the axes in FIG. 16, represent consideration levels wherein either the X power value (rectangle A) or the Y power value (rectangle B), turns out to be zero from the sum/sum calculation described above.

One of the powerful features of the present invention is that, by using the sum/sum mathematical calculation approach described herein, and recognizing that EDP addend scalar values will be either positive or negative, the system and methodology of this invention is uniquely poised to inform a user not only (a) of the situation that a reported diagnostic result of a certain character does positively indicate the likely presence some particular medical problem-type condition, but also (b) of the opposite condition—namely that a reported diagnostic result does positively indicate the likely absence of a particular medical problem-type condition.

Turning attention now to FIGS. 16-21, inclusive, here there are shown, one each in these six drawing figures, representations of combined textual and graphics (anatomical) imagery which may be presented on display screen 32 in system 30. The graphics contents in these drawing figures takes the form of suitably, conventionally regionally (i.e., by area, location, etc.) sensitized anatomic graphic components which may be presented to a user of system 30 for the purposes of: (a) informing a user about diagnostic result “output” information (output-response), such as a notable preliminary, or reportable final, output diagnostic result; (b) requesting (input-invitation) from a user, through graphical interaction by that user with one or more screen-sensitized graphical display areas based upon engine selected and presented graphical data components made available in database 36, fresh input data relevant to a medical problem type; and (c) furnishing screen-displayed graphical output data (output-response), linked (or not-linked) selectively with attendant, textual output information, in the form(s) of refinement questions or relevant diagnostic inquiries.

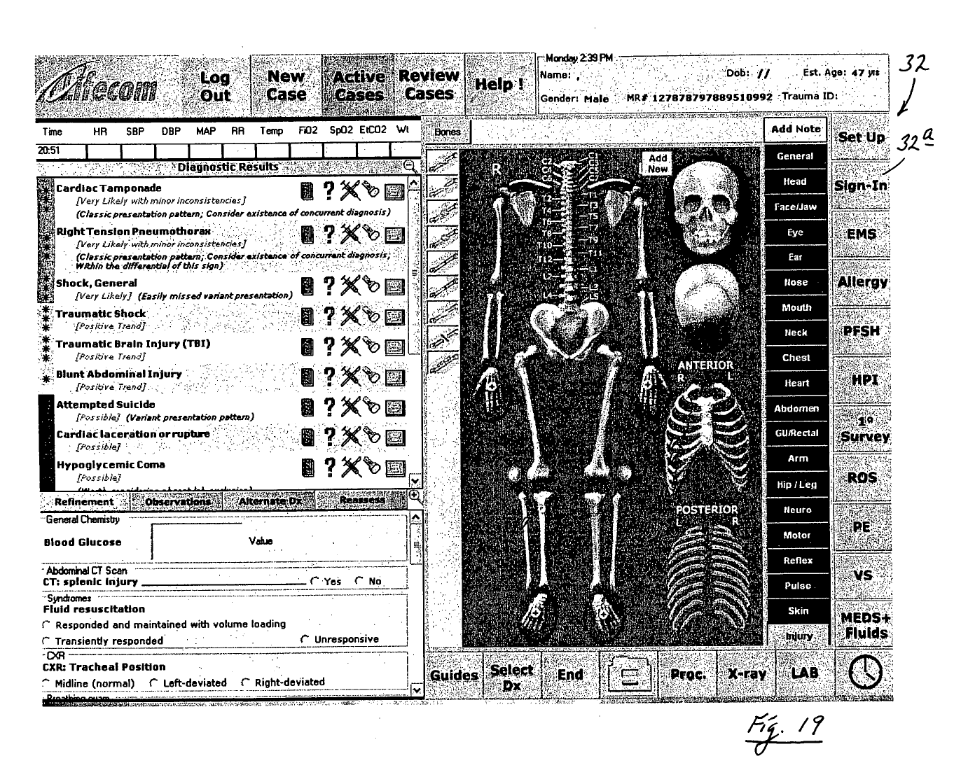

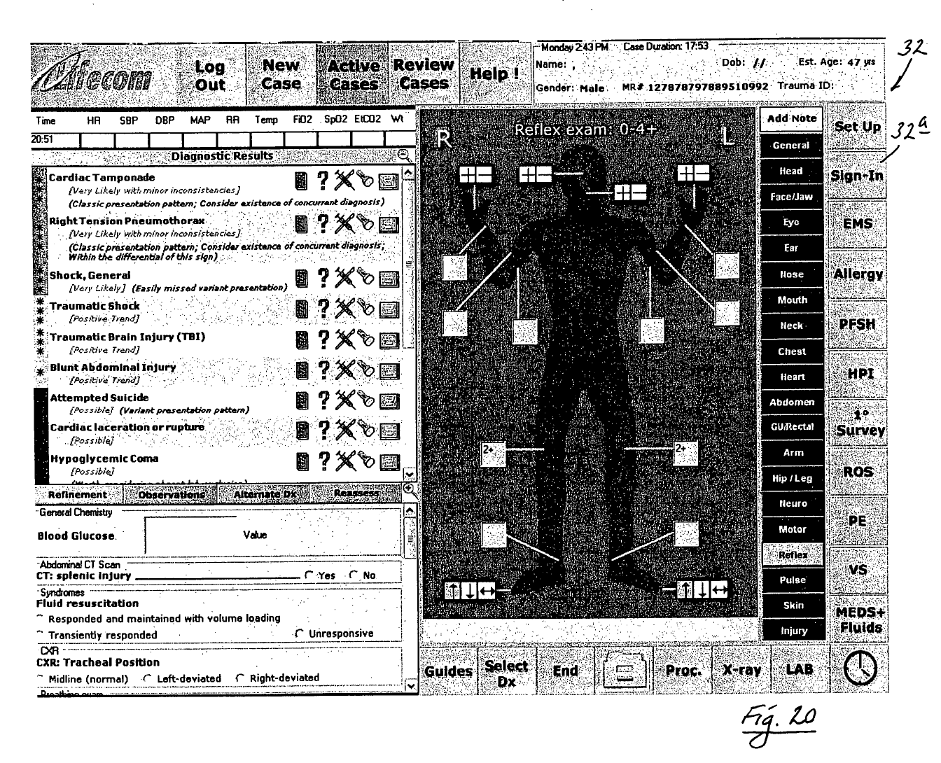

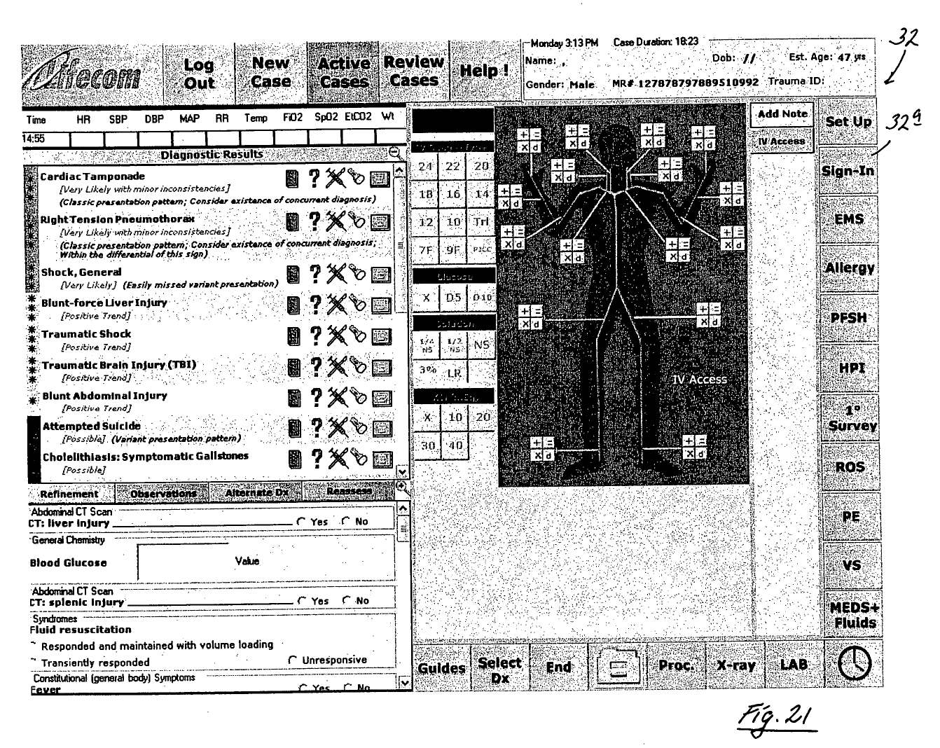

FIG. 16 provides, on the right side of display screen 32a a front and rear surface view of the basic male anatomy which may function, selectively, with regionally sensitized. FIG. 17, on the right side of display screen 32a, shows a high level anatomical view of the arterial system, marked and sensitized for the user entry of pulse (amplitude) information. FIG. 18, on the right side of screen 32a, pictures generally the muscular system with regions therein sensitized for user entry of certain regionally related musculature information. FIG. 19 provides a fragmented skeletal system view sensitized for the entry of information. FIG. 20 provides an anatomical view regionally sensitized for the entry and presentation of reflex system information. FIG. 21 furnishes a high-level schematic view of the anatomical venal system (parts thereof) sensitized for the association therewith of information involving IV insertion and removal activity.

It should be understood that, while the specific screen-display presentations utilized for illustration in FIGS. 16-21, inclusive, involve substantially full-anatomical, modest-detail images, various levels of magnification and other detail are available in the system and practice of the invention, and could have been employed in addition to, or in lieu of, the specific images chosen for these six figures.

Those skilled in the art of creating for presenting various kinds of screen displays under the control of a computer where different selectable display areas may be sensitized for user interaction will understand fully how to accomplish the display sensitizing feature of the invention, guided, of course, by system designer predetermination of the collection of normalized/non-normalized graphics data components, and/or assemblies thereof, magnifications thereof, layers or levels thereof, decided upon the particular system designer who chooses to implement the present invention in the subject domain of medicine. The “degree of graphics, data-component “granularity” is thus a matter of designer selection, along with the specifications regarding components, or component areas, to sensitize.

In the operation of system 30 with respect to its graphics capabilities, what is clearly shown in these six figures are opportunities for a user to communicate in a powerful two-way manner with system 30 using highly intuitive anatomical graphics representations based upon graphics-based data components contained in database 36. The graphics components which makeup the graphics imagery presented, as seen in these six figures, are associated, as mentioned, directly with different text-based graphics components, are endowed with relevance shortcutting as described above, offer a medically-trained user with a highly inviting and intuitive opportunity to supply input and to receive output information, including inquiries regarding diagnostic refinement, as part of a signal path between the user and system 30, and thus enhance the effectiveness of system 30 during a diagnosis/assessment process involving the assessment of a subject medical problem type.

As was mentioned earlier, with respect to the text-based operating characteristics of the system of the invention, the graphics based characteristics of the system function in essentially the same manner, and with the same powerful diagnostic and assessment capabilities, enhanced by the very nature of graphics imagery which intuitively triggers multiply levels of information for medically trained personnel who use the system of the invention.

As discussed above, graphics components which may be assembled (essentially in data-component forms, as is also true for textual components that become displayed) for viewing as imagery on display screen 32a may be provided to cover a wide variety of anatomical regions and anatomical systems, may even be motion imagery if desired, and may be capable of different levels of enlargement through “zooming” to furnish a very effective graphics dialogue between a user in the system in the carrying out of a medical problem-type assessment and diagnosis.

As was also mentioned earlier herein, the exact nature and content of graphics data components in database 36 are matters of choice, but preferably, they are as rich and complete in information as is the case with the database-contained text-based data components.

The apparatus and method of the invention are thus now fully described and illustrated in a manner showing the invention's powerful, graphics-endowed input and output ability to provide medical problem-type diagnoses and assessments. Many of the key advantages of this invention are fully set forth, and while a preferred and best mode embodiment and manner of practicing the invention have been expressly described and illustrated herein, we appreciate that variations and modifications are certainly possible, will be discernable by those generally skilled in the relevant art, and may all be made without departing from the spirit of the invention.

We claim:

1. A computer-based medical knowledge system designed for providing problem and situation diagnoses and assessments in the field of medicine comprising
an input/output communication interface zone,
an output-assessment-operative knowledge engine, and
intermediary structure operatively interposed said zone and said engine, including at least one active, diagnosis/assessment-accessible database which is effectively commonly shared by said zone and said engine, and which contains plural data components, both text-based and graphics-based, organized via relevance short-cutting into bodies of (a) normalized and (b) non-normalized data components, and wherein, within the body of non-normalized data components, there are different groups of non-normalized data components whose respective group members are collectively linked by relevance short-cutting to a common, normalized data component, but are associated, in a group-specific manner, to different, respective medical problems and/or situations.

2. The system of claim 1, wherein said interface zone takes the form of a user-interactive display screen.

3. The system of claim 1, wherein said intermediary structure further includes assessment-refinement-capability substructure, and data input presented at said interface zone is processed by the engine to progress toward an output diagnosis/assessment, and the engine, relative to a requested diagnosis/assessment, (a) is capable of determining, from input data provided to date, and from diagnostic/assessment performance, if any, which has been undertaken to date, whether there is room for refinement, and on determining that there is such room, (b) implements refinement capabilities employing said diagnosis/assessment-refinement-capability substructure to engage in a dialog manner with said interface zone.

4. The system of claim 3, wherein refinement dialog can involve requests for both data addition and data subtraction.

5. The system of claim 3, wherein a characteristic of system operation is that a diagnosis/assessment process terminates when the knowledge engine determines that no further data activity, including assessment-refinement activity, will enable further differentiation, and isolation-identification, of the specifically addressed problem and/or situation.

6. The system of claim 3, wherein an output assessment can provide both positive ruling-in and positive ruling-out, of final conclusions.

7. A computer-based medical diagnostic method for assessing different medical problems types comprising
providing access to a relevant medical knowledge system which includes (a) an engine, (b) a text and medically-based-graphics-imagery data-component database, and (c) a user-interactive screen display, and
utilizing the screen display, enabling two-way, input/output, interactive communication between a user and the system, wherein screen-displayed medically-based-graphics-imagery which is associated with, and drawn from, content in the database, under the control of the system engine, is employed both to input medical problem-type information from a user, and to output relevant medical problem-type (a) input-invitation, and (b) output-response information.

8. A medical diagnostic system for assessing different medical problem types comprising
a digital processing knowledge engine,
a database operatively connected to, and accessible by, said engine containing data content including both text-based, and graphics-based data components associated with such problems types, and
a user-interactive screen-display interface operatively connected to said engine and to said database, operable in input and output modes to enable user input, and screen invitation and response output, of medical problem-type information, including problem-type diagnostic/assessment information in data-component-associated forms.

9. A computer system for performing diagnoses of medical problem-types comprising
a digital computational engine,
a database operatively connected to said engine including a storage medium containing medical-problem-type-related, anatomical, graphics data components, some of which components have characteristics of non-normalization linked through relevance short-cutting to other components which have characteristics of normalization, and
a user-interactive, graphical interface including a display screen operatively connected both to said engine and to said database, operable under engine control to display selected ones of said components in both user-interactive sensitized-input, and user-informative-output, modes during medical problem-type diagnosis performed by the system.
